(19) United States
(12) Patent Application Publication
(10) Pub. No.: US 2009/0231118 A1
(43) Pub. Date: Sep. 17, 2009

(54) FORWARDING AND FALL BACK MONITORING IN AN ALARM SYSTEM

(75) Inventor: Jordan S. Cohen, Collegeville, PA (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Viking Electronic Services, LLC, Grand Rapids, MI (US)

(21) Appl. No.: 12/048,018

(22) Filed: Mar. 13, 2008

(51) Int. Cl. G08B 29/16

(52) U.S. Cl. 340/506

(57) ABSTRACT

A method of monitoring the status of an alarm or security system (10) installed at a facility (F). A sensor (S) responds to the occurrence of a predetermined condition by going into alarm and an indication thereof is communicated to a call center (CC) which forwards the information to a monitoring site (M1-Mn). The monitoring site then processes the information about the status condition and determines what action is to be taken in response thereto. Before forwarding the information to the monitoring site, the call center first sends a protocol message to the monitoring site querying whether or not the monitoring site is available to receive forwarded status condition information. The information is forwarded only if the monitoring site responds affirmatively to the message. Otherwise, the call center either retains and processes the received status condition information, or forwards it to a second monitoring site.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

The invention relates to alarm system monitoring; and more particularly, to a method for insuring that a remote site is continuously monitored whether by a system administrator or other monitoring agency.

Signal monitoring devices such as used in alarm and security systems receive information from electronic devices (e.g., fire sensors) and take some type of predetermined action based on that information. It is well-known that alarm or security systems installed in buildings are often remotely monitored. That is, signals from various types of sensors employed in the system (and other system information) is routed to a control panel or other central site at the building's location, and then transmitted to a remote location where information from the sensors and the status of the system is monitored. Most often, the owners or management of the building contract with a security agency to perform this monitoring function, it being understood that the agency remotely monitors a number of widely dispersed facilities at a central location. Sometimes, however, the building's owners or management may elect to assume the primary responsibility for this monitoring function. Accordingly, they will operate a facility separate and apart from that of the agency. In these instances, the monitoring facility operated by the agency functions in a backup monitoring capacity rather than as the primary monitor.

When two (or more) monitoring facilities are capable of handling the monitoring function, one location has the primary responsibility for the monitoring and the other(s) acts as a back-up so that if the primary facility goes “off-line”, the back-up facility assumes the function. In this arrangement, it is important that all communication signals sent from the monitored site be readily transferrable from the primary to the back-up facility. This requires a protocol that insures all necessary “hand shakes” between the two facilities are readily accomplished, both initially and if the primary facility goes “off line” for some reason.

### BRIEF SUMMARY OF THE INVENTION

The present disclosure is directed to a method for quickly, conveniently, and reliably switching the monitoring function for a site from one monitoring location to another. According to the method, signals from a monitored site are received based upon a pre-established action plan (e.g., time and day). The signals are forwarded via the internet (using a standard internet browser) or other communication's medium from a first location to a specified second location (which can be selected from one of a group of locations), if the second location is logged on. If the second location is not logged on, the signals remain at the first location. When queried for the transfer of signals to it, the second location has a specified time period in which to acknowledge receipt of the forwarded signals. If acknowledgement is received within the period, the first location then “drops-off” line and communications from the monitored site are forwarded directly to the second location. If acknowledgement is not received within the specified time period, the signals remain directed to the first location where the monitoring function continues to be performed.

The method allows the first station to periodically query the second station to subsequently affect a transfer when the second station is again “on-line”. Also, the second station, when it if comes “on-line” subsequent to the initial query by the first station can signal the first station that it is now ready to affect a transfer.

After transfer of the signals to the second station, the signals continue to pass through the first station. If the second station drops “off line” for any reason, the first station automatically takes over the monitoring function so no signals from the monitored site are lost or not acted upon if the need arises. In addition, the first station again starts querying the second station about resuming monitoring.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified representation of an alarm or security system with a forwarding and fall back monitoring capability; and,

FIG. 2 is a timing diagram illustrating operation of the forwarding and fall back method of the invention.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

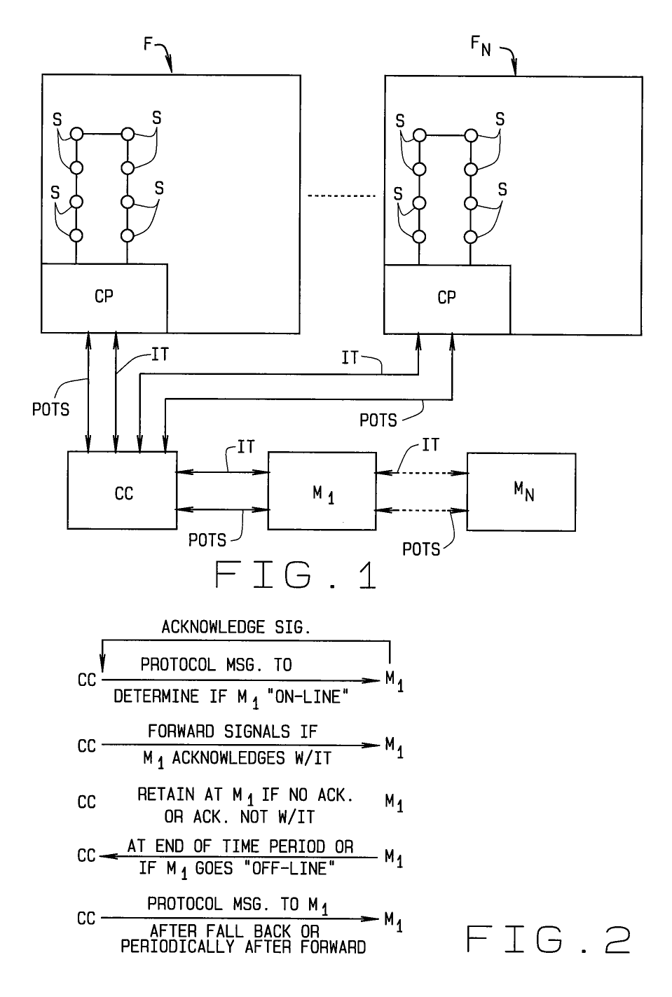

Referring to the drawings, an alarm or security system 10 is installed at a facility F. As is known in the art, the alarm system includes a control panel CP to which is connected sensors S which respond to the occurrence of a predetermined condition by going into alarm. When this occurs, an alarm indication and other pertinent status condition information (sensor location, etc.) are transmitted from the control panel to a monitoring location or call center CC. As shown in FIG. 1, the security system may include a number of monitoring locations or sites, these typically being remote from the facility. In operation, the signals from the control panel at facility F are routed through a call center CC to a monitoring site M1 . . . Mn. Call center CC therefore functions as a communications center for communications both to and from facility F, as well from a number of other facilities Fn. Typically one of the monitoring sites M1-Mn is designated the primary site and the alarm indication and associated status information is communicated from control panel CP to this monitoring site. When an alarm indication is received at a site, for example, site M1, the transmitted information is processed and a determination is made about what action is to be taken. This will include notifying the appropriate responders (police, fire, medical) as well as the owners/operators of the facility, insurers, etc.

Again as shown in FIG. 1, communications between a facility, the call center, and a monitoring site can be affected in one of a number of ways. Two ways are indicated in FIG. 1, communications over the internet IT using, for example, a standard internet browser. Or, communications is done using a conventional telephone system; i.e., a plain old telephone system or POTS.

Before sending alarm and status information to a monitoring site M1, the call center first queries that site to determine if it is “on-line” and therefore capable of receiving and processing any communications. As shown in FIG. 2, the call center does this by sending a protocol or query message (msg.) to a first monitoring site M1. This site, upon receipt of the protocol message, if capable of currently processing signals routed through the call center from a facility, sends an acknowledgement back to the call center. If the call center receives the acknowledgement within a predetermined time T after the protocol message is sent will automatically forward signals from the facility to site M1 which now processes the signals and carries out those functions required of the monitoring site.

It will be understood by those skilled in the art that once call center CC has verified that site M1 is on-line and communications from facility F are forwarded to that site, that the call center control may thereafter periodically send another protocol message to the site and request an acknowledgement that the site is still on-line. The protocol for doing this may be on hourly or other prescribed basis, or on a random or pseudo-random basis. So long as monitoring site M1 continues to provide a timely acknowledgement to each query, the call center will continue forwarding communications from the facility to the monitoring site.

If monitoring site M1 does not timely acknowledge the protocol message, or does not acknowledge it all, call center CC assumes that the site is either “off-line” or for some other reason cannot timely receive and process incoming communications from the call center. When that occurs, the call center has various options available to it. First, it can simply process signals from the facility itself, and take whatever actions are warranted as a result of the processing. Second, if there are other monitoring sites available, the call center can skip over monitoring site M1 and send a protocol message to the next listed monitoring site. If that site timely acknowledges the protocol message, then the call center begins forwarding messages from the facility to that site. Regardless of whichever actions it takes, the call center makes note of the unavailability of monitoring site M1 and informs the director of the security system that the site was unavailable.

It sometimes happens that even though a monitoring site may be operating and available when queried by the call center, so messages from the facility are forwarded to that site by the call center, the monitoring site subsequently goes off-line. It is a feature of the invention that if this occurs, there is an automatic fallback from that site to the call center with the call center now performing the same signal processing functions and related activities that the monitoring site was performing. Again, the call center makes note of the unavailability of the monitoring site and informs the director of the security system that the site has become unavailable. Further at this time, the call center may send a protocol message to one of the other monitoring sites to see if that site is available. If this second site timely acknowledges the query, the call center can again release the signals and forward them to the second monitoring site for processing.

Finally, as noted, a number of facilities may employ a security system 10. As shown in FIG. 1, communications to and from each facility are routed through the call center. In accordance with the invention, call center CC can route signals from one facility to one monitoring site and signals from another facility to a second monitoring site. The call center can also route signals from two or more facilities to the same monitoring site. In this latter situation, if the monitoring site goes off-line so that the communications fall back on the call center, the call center has the option of processing the signals at the call center, forwarding the signals from the facilities to a new monitoring site, or forwarding the signals from one facility to one new monitoring site and those from another facility to a second new monitoring site. It further has the option of retaining processing of the signals from one facility at the call center while forwarding signals from a second facility to a new monitoring site.

In view of the above, it will be seen that the several objects and advantages of the present disclosure have been achieved and other advantageous results have been obtained.

Having thus described the invention, what is claimed and desired to be secured by Letters Patent is:

1. A method of monitoring the status of an alarm or security system installed at a facility, the system comprising at least one sensor responsive to the occurrence of a predetermined condition to go into an alarm state and provide an indication thereof, and means for communicating information about the status condition of the sensor, comprising:
transmitting status condition information about the at least one sensor from the means for communicating to a first monitoring site, the first monitoring site processing information about the status condition and determining what action, if any, needs to be taken in response thereto;
forwarding the status condition information from the first monitoring site to a second monitoring site for the second monitoring site to process the information about the status condition and determining what action, if any, needs to be taken in response thereto; and,
the first monitoring site first sending a protocol message to the second monitoring site querying whether or not the second monitoring site is available to receive forwarded status condition information, and for forwarding the status condition information to the second monitoring site only if the second monitoring site responds affirmatively to the message, the first monitoring site otherwise retaining the received status condition information and not forwarding the information to the second monitoring site.

2. The method of claim 1 in which the second monitoring site has a predetermined time interval in which to acknowledge to the first monitoring site receipt of the protocol message, the first monitoring site forwarding the status condition information to the second monitoring site only if the second monitoring site acknowledges receipt of the message within the predetermined time interval.

3. The method of claim 2 in which, if the second monitoring site does not acknowledge receipt of the initial protocol message, so that the first monitoring site continues receiving and processing the information and does not forward the information to the second monitoring site, the first monitoring site thereafter periodically sends the protocol message to the second monitoring site and forwards the information to the second monitoring site if the second monitoring site acknowledges receipt of the subsequent message within the predetermined time interval, but the first monitoring site otherwise continuing to receive and process the status condition information at that site and not forward the information to the second monitoring site.

4. The method of claim 2 in which, if the second monitoring site does not respond affirmatively to the message, the first monitoring site, while continuing to receive and process the information, sends the protocol message to another monitoring site and forwards the information to said another monitoring site if said another monitoring site acknowledges receipt of the message within the predetermined time interval; but, if the first monitoring site does not receive an acknowledgement from the said another monitoring site within the predetermined time interval, the first monitoring site does not forward the information to said another monitoring site but rather continues to receive and process the status condition information.

5. The method of claim 4 in which the first monitoring site thereafter periodically sends the protocol message to the said another monitoring site and forwards the information to the said another monitoring site if the said another monitoring site acknowledges receipt of the subsequent message within the predetermined time interval.

6. The method of claim 5 in which the first monitoring site does not continue to process any status condition information forwarded to the second monitoring site.

7. The method of claim 6 in which the first monitoring site further does not continue to process any status condition information forwarded to said another monitoring site.

8. The method of claim 1 in which the first monitoring site functions as a fall back site for receiving and processing the status condition information if, after the information is forwarded to the second monitoring site, the second monitoring site is subsequently unable to continue processing the information.

9. The method of claim 4 in which the first monitoring site functions as a fall back site for receiving and processing the status condition information if, after the information is forwarded to the said another monitoring site, the said another monitoring site is subsequently unable to continue processing the information.

10. The method of claim 1 in which the status condition information, protocol message, and acknowledgement are all transmitted via the internet.

11. The method of claim 1 in which the forwarding of the status condition information occurs at pre-established times.

12. The method of claim 1 in which the second monitoring site receives and processes status condition information from a plurality of first monitoring sites each of which forwards status condition information to the second monitoring site only if the second monitoring site acknowledges receipt of a protocol message from the respective first monitoring site.

13. A method of monitoring the status of an alarm or security system installed at a facility, the system comprising a plurality of sensors each of which is responsive to the occurrence of a predetermined condition to go into an alarm state and a control panel to which the sensors are connected and which provides status condition information about the sensors to a monitoring site, comprising:
transmitting the information about the sensors to a first monitoring site which site processes the information about the status condition of the sensors and determines what action, if any, needs to be taken in response thereto;
forwarding the information from the first monitoring site to a second monitoring site for the second monitoring site to process the information and determine what action, if any, needs to be taken in response thereto, the first monitoring site first sending a protocol message to the second monitoring site querying whether or not the second monitoring site is available to receive forwarded status condition information, and for forwarding the status condition information to the second monitoring site only if the second monitoring site responds affirmatively to the message within a predetermined time interval, the first monitoring site otherwise retaining and processing the received status condition information and not forwarding the information to the second monitoring site; and.
the first monitoring site functioning as a fall back site for receiving and processing the status condition information if, after the information is forwarded to the second monitoring site, the second monitoring site is subsequently unable to continue processing the information.

14. The method of claim 13 in which, if the second monitoring site does not acknowledge receipt of the initial protocol message, the first monitoring site thereafter periodically sends the protocol message to the second monitoring site and forwards the information to the second monitoring site if the second monitoring site acknowledges receipt of the subsequent message within the predetermined time interval, but the first monitoring site otherwise continuing to receive and process the status condition information at that site and not forward the information to the second monitoring site.

15. The method of claim 14 in which the first monitoring site does not continue to process any status condition information forwarded to the second monitoring site.

16. The method of claim 13 in which the forwarding of the status condition information occurs at pre-established times.

17. The method of claim 1 in which the status condition information, protocol message, and acknowledgement are all transmitted via the internet.
